(19) United States
(12) Patent Application Publication
(10) Pub. No.: US 2004/0187321 A1
(43) Pub. Date: Sep. 30, 2004

(54) Power saw with guide assembly

(76) Inventors: Markus Hartmann, Mauerstetten (DE); Armin Below, Kaufering (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/820,351

(22) Filed: Apr. 8, 2004

(30) Foreign Application Priority Data
Apr. 11, 2001 (DE) 103 16 633.5

(51) Int. Cl. B23D 49/16

(52) U.S. Cl. 30/377; 30/392

(57) ABSTRACT

A motor-driven power saw (2) is formed of a housing (4), on which a guide assembly (9) for guiding the power saw (2) on a work piece is removably attached at a tool opening (5) in the region of a device collar (3), whereby the guide assembly (9) has a connecting assembly (10) having two connecting parts (14) and a connecting receptacle assembly (12) is formed on the housing (4), providing a guide for the connecting parts (14) and which can be secured at the connecting parts (14) by means of a form fit with an adjusting assembly (36) relative to the housing (4). The connecting parts (14) are formed rodlike and have a rounded cross-section at least regionally. The connecting parts (14) have a rodlike shape and, at least regionally, have a rounded cross-section.

### BACKGROUND OF THE INVENTION

The invention relates to a motor-driven power saw having a housing, on which a guide assembly is removably mounted for guiding a saber saw on a work piece in the region of a device collar at a tool opening, whereby the guide assembly has a connection device having two connection parts and extends into the housing and provides a guide for the connection parts and which can be affixed to the connection parts by a form fit connection with an adjusting assembly relative to the housing.

In known saber saws, normally a guide means, such as a guide shoe or a tubular adapter is provided, in order to achieve safe and precise guiding of the saber saw on a work piece. In this fashion, the guide means makes it possible for the operator of the saber saw to achieve a precise cut on a work piece having an at least regionwise planar or rounded cross section.

U.S. Pat. No. 5,421,091 discloses a saber saw having a housing, guide shoe for guiding the saber saw on a work piece and having a motor driven, pendulumlike reciprocating rod. The guide shoe is pivotably mounted at one end of a connection rail having a longitudinal slot, whereby the connecting rail is guided in an essentially parallelepiped, flat housing slot and can be form fittingly affixed.

DE 199 32 637 discloses a saber saw having a housing, a guide shoe for guiding the saber saw on a work piece and with a motor driven, pendulumlike reciprocating rod. The guide shoe is mounted in bearings so that it can swing out on one end of the slide rod, which is positioned slidingly in the housing and can be secured to the housing by means of an adjusting assembly. For this purpose, the adjusting assembly has a bolt, at the head of which a bolt tightening lever is engaged. By swinging out the bolt tightening lever, the slide rod can be fixedly clamped from a released condition by means of the bolt on the housing or released from the clamped condition.

The drawback of the two known solutions is that on the one hand in the form-fitting fixation of the connecting assembly a high degree of precision is required in manufacturing the connecting assembly and for the connection receiving assembly in order to achieve an adequate cut quality. In addition, in the adjusting assembly used in this case, when adjusting the connecting assembly cants can easily result, which in turn result in unsatisfactory handling of the guide means. On the other hand, in the force-locking securing, a sufficiently stable and precise securing of the connecting assembly is possible only using a relatively high degree of force, which when installing, shifting or removing the connecting assembly also results in difficult handling.

### SUMMARY OF THE INVENTION

The object of the present invention is to eliminate the aforementioned drawbacks in a power saw having a guide means and to provide precise guiding with easy handling.

According to the invention, the object is achieved in that the connecting parts are formed rodlike and have at least regionwise a rounded cross-section. By virtue of the at least regionwise rounded cross section of the connecting parts, in particular in the region, that is arranged inside the guide means receptacle in the secured condition of the guide means, canting between the connecting assembly and the housing can be prevented to a maximum degree. Consequently, on the one hand a very stable securing of the connecting assembly on the housing is achieved by an inner lever arm between the connecting parts and the form-locking adjusting assembly both with regard to torsion and also in the direction of movement of the power tool. On the other hand, satisfactory handling when installing, adjusting or removing the guide means is possible at all times. Furthermore, the manufacturing costs of the connecting parts is relatively low on account of their rodlike shape.

The connecting receptacle assembly advantageously has its own connecting slot in the housing for each of the connecting parts, in order to make possible a maximally stable guiding of the guide means.

Preferably, the connecting recesses each have at least regionally a rounded cross-section, into which the respective connecting part with the region having a rounded cross section can be guided. In this fashion, a particularly precise guiding of the connection parts into the connecting part receptacles is achieved, which provides for a particularly stable connection between the guide means and the housing when securing the connecting assembly using the adjusting assembly and accordingly at the time of the cutting operation enables precise guidance of the power saw.

Advantageously, at least one of the connecting parts has a plurality of constrictions in the region having the rounded cross-section. One part of a locking element can be placed in these constrictions. In this way, a stable securing of the connecting assembly in the direction of movement of the power tool is achieved. In addition, this type of adjusting assembly is relatively inexpensive to manufacture.

Advantageously, the connecting parts have a spacing at the power tool end that is 0.3 to 0.9 times the width of the housing. In this way, a relatively large lever arm between the connecting parts is obtained, which makes possible, in particular relative to torsion, stable securing of the guide means on the housing. Furthermore, by virtue of the relatively large spacing and the alignment of the connecting parts in the longitudinal sense of the collar of the device an optimum view of the work region is achieved.

Advantageously the connecting assembly has at least one connecting web, which securely connects the two connecting parts with each other in order to assure a high degree of stability of the connecting assembly, especially in the region of the guide means.

The connecting web is preferably arranged on the power tool end of the connecting parts, in order to assure, particularly in the working region, maximum rigidity of the connecting assembly.

The connecting web is preferably formed with a U-shaped cross-section, in order to make it possible to establish a stable connection with the connecting parts.

Advantageously, the connecting web has fastening means for rotational mounting of the guide means. In this way, mounting of the guide means can be effected substantially independently of the connecting parts, which results in lower costs of manufacturing.

The connecting web is preferably manufactured using a bend-punch part, in order to provide for economical manufacturing of the connection assembly.

### BRIEF DESCRIPTION OF THE DRAWING

The invention will be more completely explained with reference to an exemplary embodiment. Wherein:

FIG. 1 is a perspective view of the gearing part of a power saw according to the invention with the guide assembly removed therefrom;

FIG. 2 is a perspective exploded view of the guide assembly represented in FIG. 1, and

FIG. 3 is a perspective view of the underside of the gearing housing with an exploded representation of the adjusting assembly.

### DETAILED DESCRIPTION OF THE INVENTION

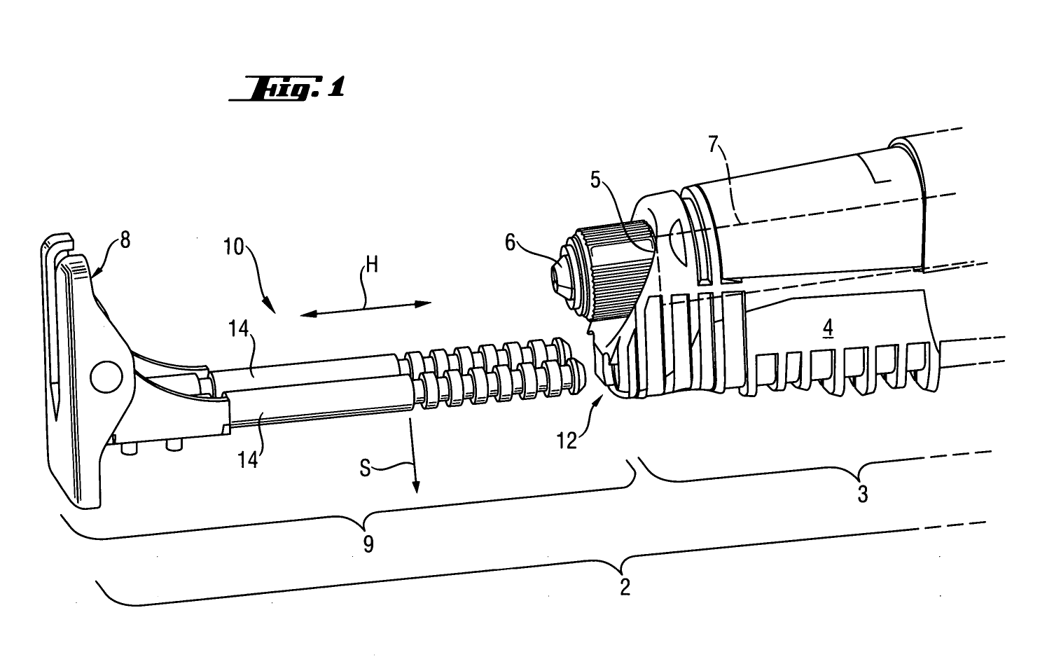

FIG. 1 shows the front part of a motor-driven power saw 2. The power saw has a housing 4, which has a tool opening 5 on the front end and forming a device collar 3 in the direction thereof, the collar being used as a handle when operating the power tool. Therefore, in the end-mounted condition the device collar 3 is surrounded by a hand shield, which is not represented in order to facilitate understanding.

In operation a tool receptacle 6 reciprocates together with a saw blade (not shown) through the tool opening 5, which is mounted at the free leading end of a reciprocating rod 7 (indicated by a broken line).

A guide assembly 9 having a guide means 8 in the form of a guiding shoe at its leading end is represented separated from the housing part 4. The guide means 8 is secured on the housing 4 via a connecting assembly 10, which is inserted in the longitudinal direction of the power tool collar 3 into a connecting receptacle assembly 12 of the housing.

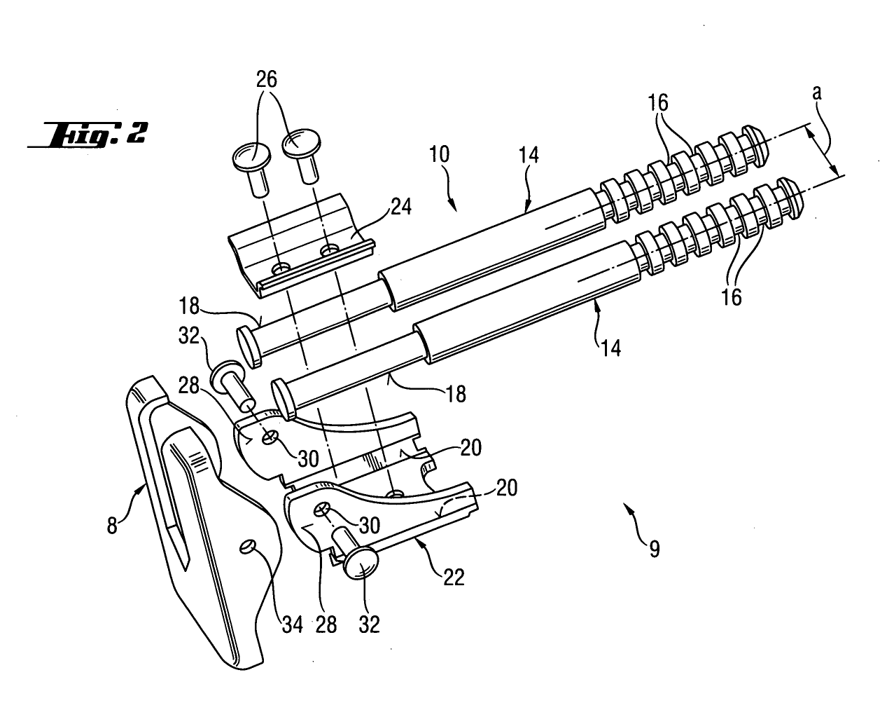

FIG. 2 shows the guide assembly 9 in an exploded representation. As can be seen in the representation, the connecting assembly 10 has two elongated rodlike connecting parts 14 each having a rounded cross-section. These have at each respective trailing end a plurality of locking constrictions 16 of equal size and arranged equidistant from each other. On the opposing leading end, both connecting parts 14 each have a fastening constriction 18.

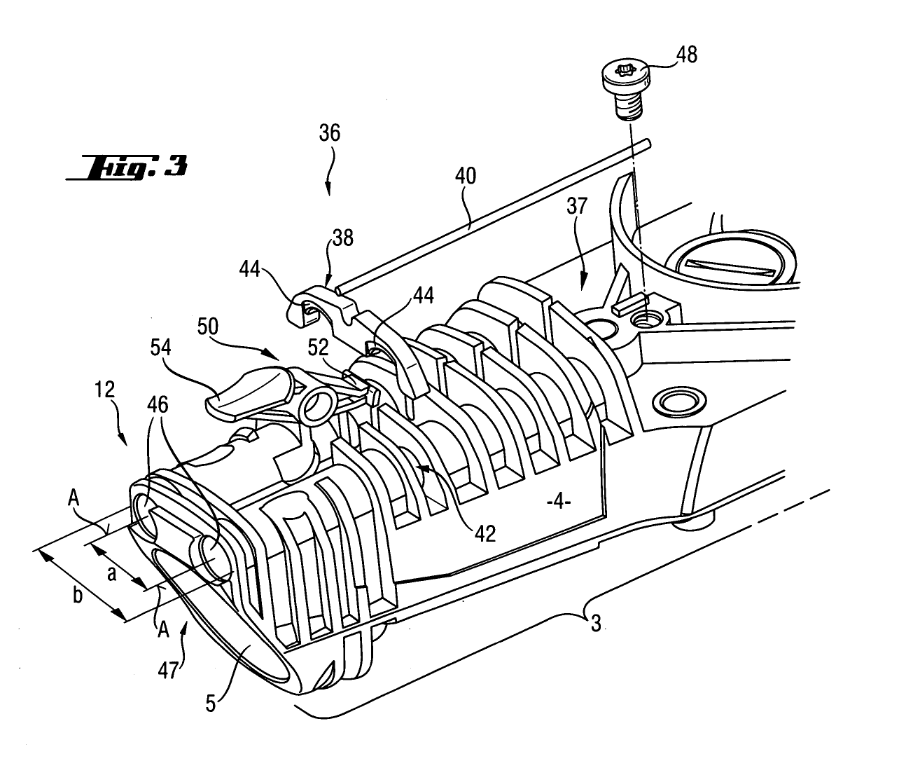

When assembling the guide assembly 9, the connecting parts 14 together with their fastening constrictions 18 are each connected to a correspondingly formed contact section 20 of a connecting web 22 and securely clamped therein by means of a shaped plate 24, which is fastened using two fastening rivets 26 to the connecting web 22. In the assembled condition of the guide assembly 9 the connecting parts 14 are arranged parallel to each other and have an axial spacing a, which corresponds to 0.3 to 0.9-times the width b of the power-tool end of the housing 4, note FIG. 3.

The connecting web 22 is formed having a substantially U-shaped cross-section and has at each of its leading free ends 28 a pair of receptacle recesses 30 for a bearing bolt 32. In the assembled condition these bearing bolts 32 each protrude through a rotary axis recess 34, arranged on two opposite sides of the guide means 8. In this fashion, the guide means 8 can be held pivotably around the bearing bolts on the connecting web 22 about the receiving recesses 30 and the bearing bolts 32 and accordingly act as fastenings for the rotational mounting of the guide means 8 on the connecting web 22 or on the connecting assembly 10.

FIG. 3 represents an adjusting assembly 36 for the connecting assembly 10, which is arranged on the underside 37 of the housing 4. This has a locking element 38, which in the unactuated condition is urged by a rodlike spring element 40 into a housing opening 42 of the housing 4. In this case, the locking element 38 protrudes with each of its locking sections 44 into one of two substantially cylindrical connecting recesses 46 of the connecting receptacle assembly 12, which extend essentially in the long direction of the device collar 3. The axes A of the two connecting recesses. 46 have a spacing a, which corresponds to the axial spacing a of the connecting parts 14 in a region of 0.3 to 0.9-times the width b of the housing 4 at its leading power-tool end region 47.

The spring element 40 is fastened, at its end facing away from the locking element 38, that is its trailing end, by a screw 48 to the housing 4. Furthermore, a balancing element 50 is provided, which abuts with its trailing end 52 on the locking element 38 and can be operated using a button-shaped actuator 54 at the leading end.

When fastening the guide means 8, the connecting parts 14 of the connecting assembly 10 are urged into the connecting recesses 46 of the connecting receptacle assembly 12. At the same time the operating actuator part 54 of the balancing element 50 is compressed. In this way, the trailing end 52 of the locking element 38 moves against the force of the spring element 40. As a result, the locking sections 44 of the locking elements 38 are moved out of the connecting recesses 46, so that the connecting parts 14 can be urged past the locking element 38 into the connecting receptacle assembly 12.

As soon as a desired spacing of the guide means 8 relative to the housing 4 is established, the actuating part 54 of the balancing element 50 is released. This results in that the spring element 40 of the locking element 38 is displaced with the locking sections 44 through the housing opening 42 into the connecting recesses 46. Hereby, the locking sections 44 engage into the constrictions 16 of the two connecting parts 14, which in this position of the connecting assembly 10 are arranged at the housing opening 42. Accordingly, the guide means 8 is secured relative to the housing 4 of the power saw 2 by means of the form fit of the connecting assembly 10 with the adjusting assembly 36 in the longitudinal sense of the device collar. At the same time, the rounded cross-sections of the connecting parts 14 in the two cylindrical connecting recesses 46 provide for a high degree of torsional rigidity.

In order to change the spacing of the guide means 8 relative to the housing 4, the actuator part 54 is pressed once again and the guide means 8 together with the connecting assembly 10 is shifted into the requisite position. Guiding of the rounded cross-sections of the connecting parts 14 into the cylindrical connecting recesses 46 accordingly provides for smooth adjustability of the connecting assembly 10 in the connecting receptacle assembly 12. In the new position the balancing element 50 is then released as hereinbefore described, so that the locking element 38 can form-fittingly engage in the adjusted locking constrictions 16.

In like manner, with the balancing element 50 actuated, it is also possible to completely remove the guide means 8 together with the connecting assembly 10 from the housing 4 of the power saw 2.

What is claimed is:

1. A motor-driven power saw (2) comprises an elongated housing (4), having a leading end and a trailing end, a guide assembly (9) for guiding the power saw (2) on a work piece is removably attached in the region of a device collar (3) at a tool opening (5), in the leading end of said housing, said guide assembly (9) having an elongated connecting assembly (10) with two connecting parts (14) and a connecting receptacle assembly (12) formed on and extending in the elongated direction from the leading end of said housing (4), said connecting receptacle assembly (12) forms a guide for said connecting parts (14) and is secured by a form fit with an adjusting assembly (36) on said housing (4), said connecting parts (14) are elongated rodlike members with a rounded cross-section in at least an elongated section thereof.

2. A power saw, as set forth in claim 1, wherein said connecting receptacle assembly (12) has a separate connecting recess (46) in said housing (4) for each of said connecting parts (14).

3. A power saw, as set forth in claim 2, wherein said connecting recesses (46) have at least in a region thereof a rounded cross-section in which the respective connecting part (14) can be guided in the region having a rounded cross-section.

4. A power saw, as set forth in claim 3, wherein at least one of said connecting parts (14) has a plurality of spaced reduced diameter locking constrictions (16) in the region with the rounded cross-sections, and a locking element (38) can be partially shifted into one of said locking constructions.

5. A power saw, as set forth in claim 4, wherein said axes (A) of the connecting parts (14) have a spacing (a), corresponding approximately to 0.3 to 0.9 times the width (b) of said housing (4) in the leading end region 47 of said housing (4).

6. A power saw, as set forth in claim 1, wherein said connecting assembly (10) has at least one connecting web (22) for securely connecting said connecting parts (14) together.

7. A power saw, as set forth in claim 6, wherein said connecting web (22) is located adjacent the ends of said connecting parts (14) spaced outwardly from said housing (4).

8. A power saw, as set forth in claim 7, wherein said connecting web (22) has a U-shaped cross-section.

9. A power saw, as set forth in claim 8, wherein said connecting web (22) has fastening means (30, 32) for rotationally mounting said guide means (8).

10. A power saw, as set forth in claim 6, wherein said connecting web (22) is formed of a bent-punch part.
